(19) United States
(12) Patent Application Publication
(10) Pub. No.: US 2006/0167751 A1
(43) Pub. Date: Jul. 27, 2006

(54) Method and apparatus for distributing music

(76) Inventor: Shigeo Maruyama, Tokyo (JP)

Correspondence Address: Reed Smith LLP, Suite 1400, 3110 Fairview Park Drive, Falls Church, VA, 22042-4503, US

(21) Appl. No.: 11/291,968

(22) Filed: Dec. 2, 2005

(30) Foreign Application Priority Data
Jan. 27, 2005 (JP) 2005-019982

(51) Int. Cl. G07G 1/14; G06Q 30/00; G06F 15/16; H04H 9/00; H04N 7/16

(52) U.S. Cl. 705/14; 725/8; 725/14; 709/217

(57) ABSTRACT

A music distribution system allows users to freely download music data that has not been put on the market or that has been created by unknown singers or musicians. In this system, which distributes music data to terminal devices via a communications network, a free music distribution Web site for distributing music data for free and a fee-based music distribution Web site for distributing music data for a fee are opened. When a request for distribution of certain music data is received from a user via the free music distribution Web site, the music data is distributed to the user for free, and the number of downloads is tallied each time the music data is distributed. Based on the result of tallying of the number of downloads, it is determined whether or not the music data should be transferred to the fee-based music distribution Web site, and the music data that has been determined to require transfer is transferred from the free music distribution Web site to the fee-based music distribution Web site.

### BACKGROUND OF THE INVENTION

1. Field of the Invention

The present invention relates to a method and apparatus for distributing music data to user terminals via communications networks, such as the Internet.

2. Background Art

Systems for distributing music data or video data to user terminals via communications networks, such as the Internet, are now common. In such distribution systems, users access a predetermined distribution site via their own terminals, and then download desired music data or video data. Fees are paid through credit cards, for example.

Patent Document 1: JP Patent Publication (Kokai) No. 2001-188735 A

Patent Document 1: JP Patent Publication (Kokai) No. 2001-318682 A

Patent Document 1: JP Patent Publication (Kokai) No. 2002-108350 A

### SUMMARY OF THE INVENTION

In the conventional distribution systems, only music data that are already commercially available in the form of CD, DVD, or tapes are being distributed. Therefore, users are currently unable to download music data that have not yet been put on the market.

It is therefore an object of the invention to provide a music distribution system for allowing users to download music data freely, such as music data for which there has not been any previous distribution channels, or music data created by unknown musicians who have not had any chance for publicizing their music.

The invention provides a method of distributing music to terminal devices via a communications network, said method comprising the steps of:

opening a free music distribution Web site for distributing music data for free and a fee-based music distribution Web site for distributing music data for a fee;

distributing music data for free to a user when a request for the distribution of music data is received from said user via said free music distribution Web site;

tallying the number of downloads each time the music data is distributed in the distribution step;

determining, based on the result of tallying of the number of downloads, whether or not the music data should be transferred to the fee-based music distribution Web site; and

transferring the music data determined to require transfer from the free music distribution Web site to the fee-based music distribution Web site.

In accordance with the invention, users can download music data that has not been put on the market for free. The invention also allows for quick determination of whether or not a particular new song or a piece of music can be promoted on a commercial basis based on direct user input.

### BRIEF DESCRIPTION OF THE DRAWINGS

FIG. 1 shows an example of a music distribution system according to the invention.

FIG. 2 shows an example of the configuration of a music distribution server according to the invention.

FIG. 3 shows a flowchart of the operation of a free music distribution unit in the music distribution server according to the invention.

FIG. 4 shows a flowchart of a process for adding newly arrived music data according to the invention.

FIG. 5 shows a flowchart of a process for deleting music data according to the invention.

FIG. 6 shows a flowchart of a process for tallying the number of download users according to the invention.

FIG. 7 shows a flowchart of a process concerning prize competition applications according to the invention.

FIG. 8 shows a flowchart of a process for transferring music data from a free music distribution Web site to a fee-based music distribution Web site according to the invention.

FIG. 9 shows an example of a Web page for soliciting music data according to the invention.

FIG. 10 shows an example of music data registered in an original database according to the invention.

FIG. 11 shows an example of a top page of the free music distribution Web site provided by a free music distribution Web site managing unit according to the invention.

FIG. 12 shows an example of a page that displays a new arrivals list in its entirety according to the invention.

FIG. 13 shows an example of a page that displays a new arrivals list by genre according to the invention.

FIG. 14 shows an example of a page that displays a ranking of the number of download users with respect to all music titles.

FIG. 15 shows an example of a page that displays a ranking of the number of download users by genre according to the invention.

FIG. 16 shows an example of a page that displays a music list for users to download music data according to the invention.

FIG. 17 shows an example of a prize competition application page according to the invention.

FIG. 18 shows a flowchart of a process performed in a music project implementation management unit according to the invention.

FIG. 19 shows an example of a Web page displaying information about planned music events according to the invention.

### DESCRIPTION OF PREFERRED EMBODIMENTS OF THE INVENTION

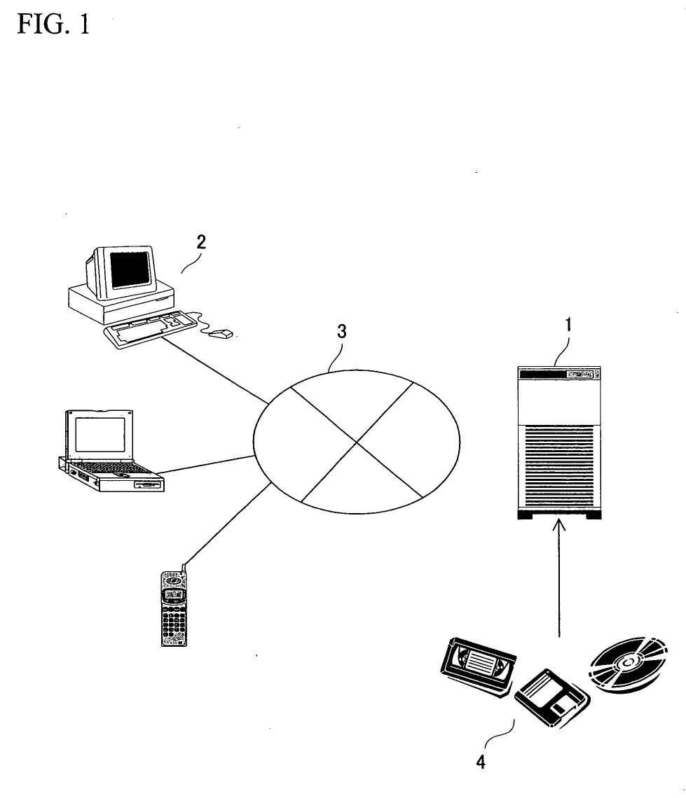

With reference to FIG. 1, an example of a music distribution system according to the invention is described. The music distribution system of the example includes a music distribution server 1 and a user terminal device 2, both of which are connected via a communications line 3, such as the Internet. The terminal device 2 may be any type of terminal device having communications and Web browsing capabilities, such as a personal computer, a cell phone, a portable information terminal, or a portable gaming machine. The music distribution server 1 has a Web server capability and a music data distributing capability.

In accordance with the invention, the music distribution server 1 causes music data 4, which is submitted by singers or musicians, to be displayed on a music distribution Web site and distributes the data to general users for free. If the number of users who downloaded the data for free exceeded a predetermined number, or other predetermined conditions have been met, the music data is transferred from the free download site to a fee-based download site.

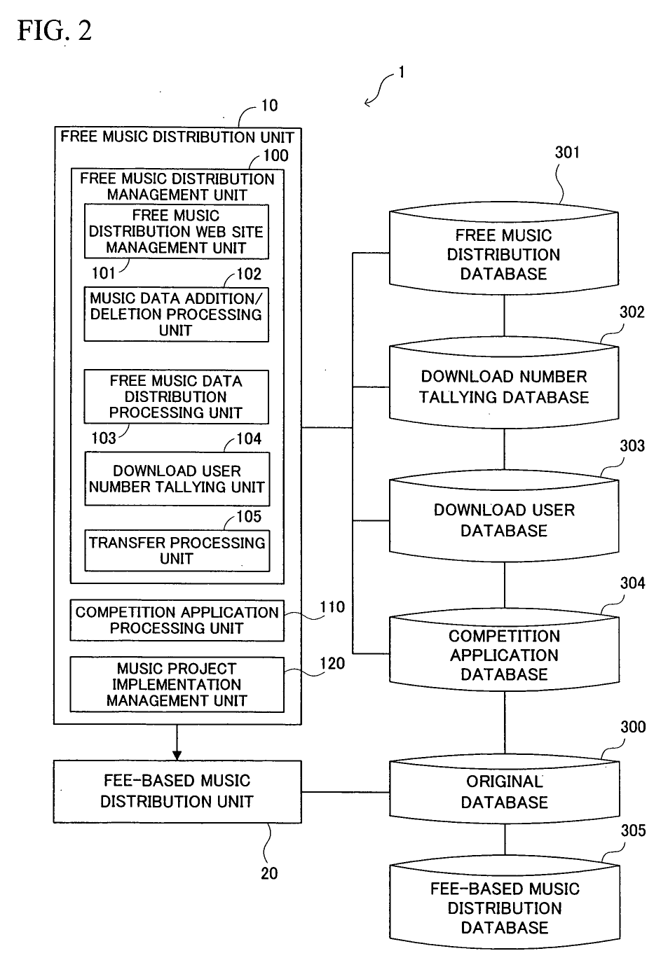

FIG. 2 shows an example of the configuration of the music distribution server 1, which includes a free music distribution unit 10 and a fee-based music distribution unit 20. The fee-based music distribution unit 20 is adapted to open a fee-based music distribution Web site so as to distribute music data to users for a fee. Such system is known and its details will not be described herein.

The free music distribution unit 10 includes a free music distribution management unit 100 for distributing music data to users for free, a competition application processing unit 110 for accepting and processing applications for entry in a competition in which users predict the title of song that will have been downloaded by the largest number of users, and a music project implementation management unit 120 for implementing and managing risk-averted music projects. The free music distribution management unit 100 includes a free music distribution processing unit 101 for opening and managing a free music distribution Web site. The management unit 100 also includes a music data addition/deletion processing unit 102 for adding or deleting music data gathered from singers or musicians to or from music lists on the free music distributing Web site. It also includes a free music data distribution processing unit 103 for distributing music data for free in response to user demands. It further includes a download user number tallying unit 104 for tallying the number of users who have downloaded free music data according to music titles. The free music distribution management unit 100 also includes a transfer processing unit 105 for transferring those music titles offered on the free music distributing Web site that are downloaded by many users to the fee-based music distribution Web site.

The music distribution server 1 further includes an original database 300, a free music distribution database 301, a download number tallying database 302, a download user database 303, a competition application database 304, and a fee-based music distribution database 305. The original database 300 stores all of the music data offered by singers or musicians on a permanent basis. The free music distribution database 301 stores the music data carried on the music lists in the free music distributing site. The download user database 303 has registered therein data regarding the members registered in the free music distributing site. The membership data includes at least user names, passwords, user ID numbers, and e-mail addresses. It may also include real names, addresses, telephone numbers, sex, date of birth, occupation, and/or credit card numbers for settlement purposes. Passwords are set by users themselves, while the user ID numbers are allocated to the users by the music distribution server 1. The competition application database 304 has registered therein information regarding prize competitions. The fee-based music distribution database 305 stores music data carried on the music lists in the fee-based music distribution site.

With regard to the hardware configuration of the music distribution server 1, which is not described in detail herein, the server may typically be comprised of a computer apparatus including a CPU, a memory, and a hard disc, for example. The above-described capabilities may be realized in the form of either hardware or software.

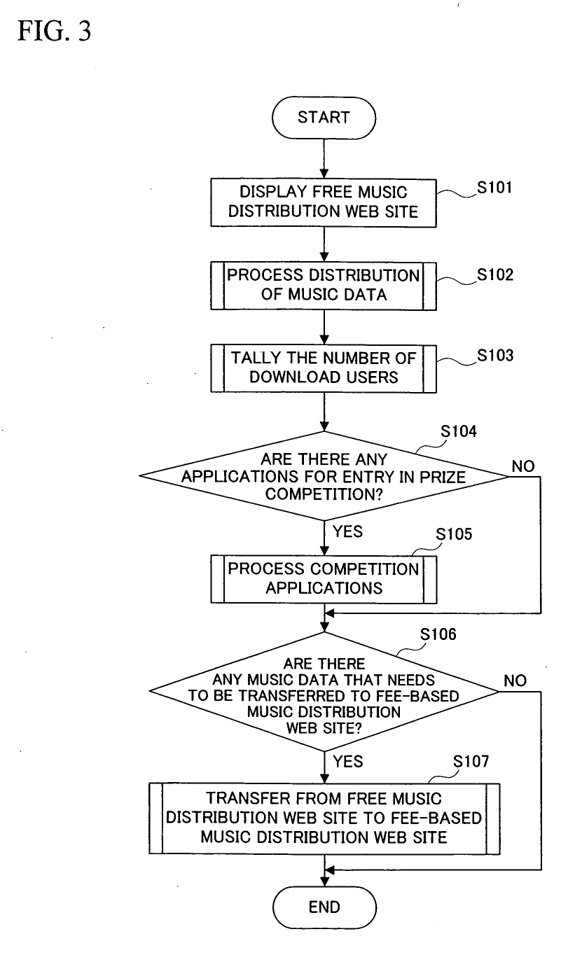

With reference to FIG. 3, the operation of the free music distribution unit 10 of the music distribution server 1 is described. At step S101, the free-music-distributing-Web-site management unit 101 causes a Web site for free music download to be displayed, to which users can freely access via their terminal devices. This Web site is herein designated as “Free Download Store.” Users can access the Free Download Store using the browsing capability of their terminal devices and have a predetermined Web page displayed.

At step S102, the free music data distribution processing unit 103 distributes music data for free in response to user demands. In the present example, it is assumed that only those who have completed a predetermined registration process can enjoy the benefit of free download. A user initially opens the top page of the free music distribution Web site, and then enters his or her password and user ID number or the like. A download page is then displayed, showing lists of music titles available for free downloaded. The user selects a desired music title and then clicks a “Download” button. When registering for membership, the user clicks a “Membership registration” button displayed in the top page. When an entry page is displayed, the user enters necessary data in the predetermined spaces. Entered data includes at least user name, password, and e-mail address. Optionally, the data may further include real name, address, telephone number, sex, date of birth, occupation, and/or credit card number for settlement purposes. The password is set by the user themselves. After the predetermined items have been entered, the music distribution server 1 may allocate a user ID number to the user and sent it via mail, for example.

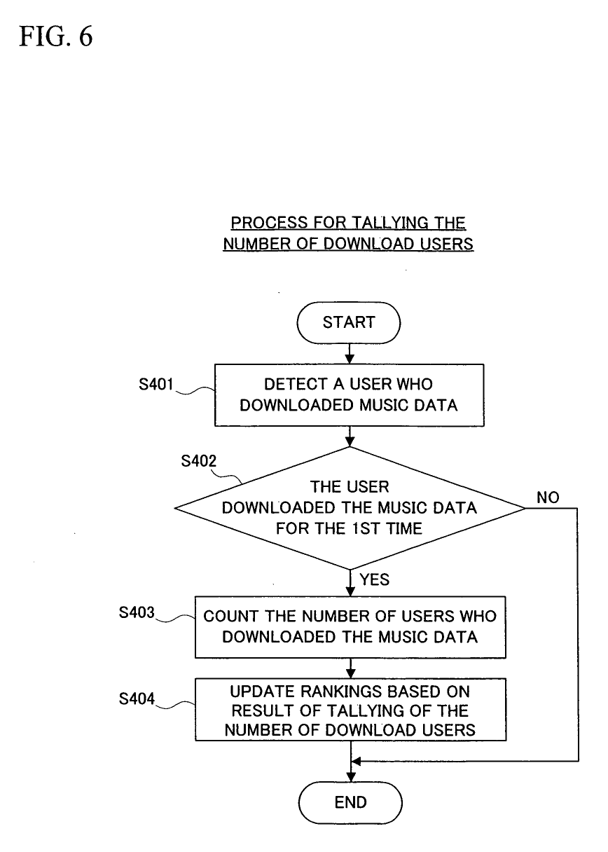

At step S103, the download user number tallying unit 104 tallies the number of download users for each music title and creates a ranking of the number of download users. The details of the tallying process for the number of download users at step S103 will be described later with reference to FIG. 6.

At step S104, the competition application processing unit 110 determines whether or not the users who downloaded have applied for entry in a prize competition. In the competition, the users predict on the Web site the music title that will be at the top of the download ranking within a predetermined period. The user with the winning prediction is awarded a prize, such as prize money.

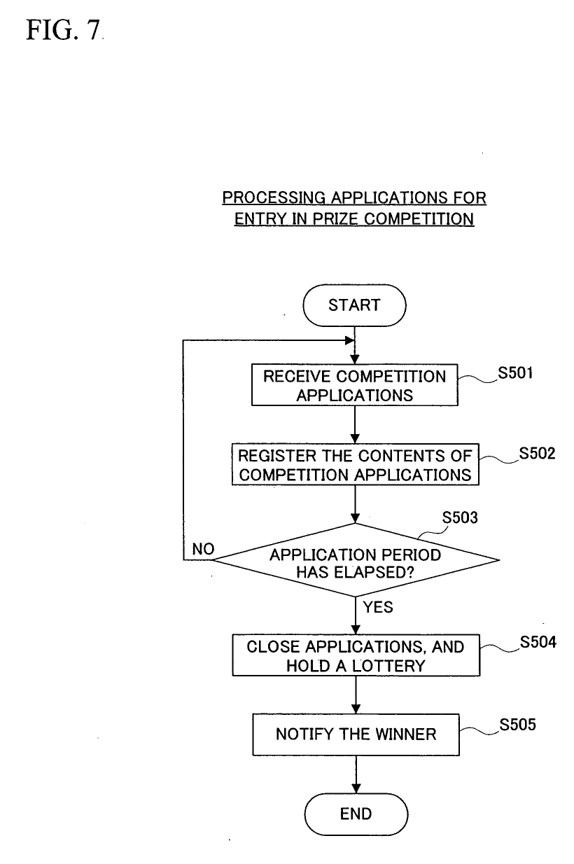

When competition applications have been received, the routine proceeds to step S105, where the competition application processing unit 110 processes the competition applications, followed by step S106. The details of the competition application process at step S105 will be described later with reference to FIG. 7. If there are no applications for entry in the competition, the routine proceeds directly to step S106.

At step S106, the transfer processing unit 105 determines whether or not there are any music titles carried on the music lists in the free music distribution Web site that should be transferred to the fee-based music distribution Web site. For example, music titles that have been downloaded by more than a predetermined number of users may be designated for transfer to the fee-based music distribution Web site. Alternatively, the music title that has made it to the top of the download ranking and that has been downloaded by more than a predetermined number of users may be designated for transfer to the fee-based music distribution Web site.

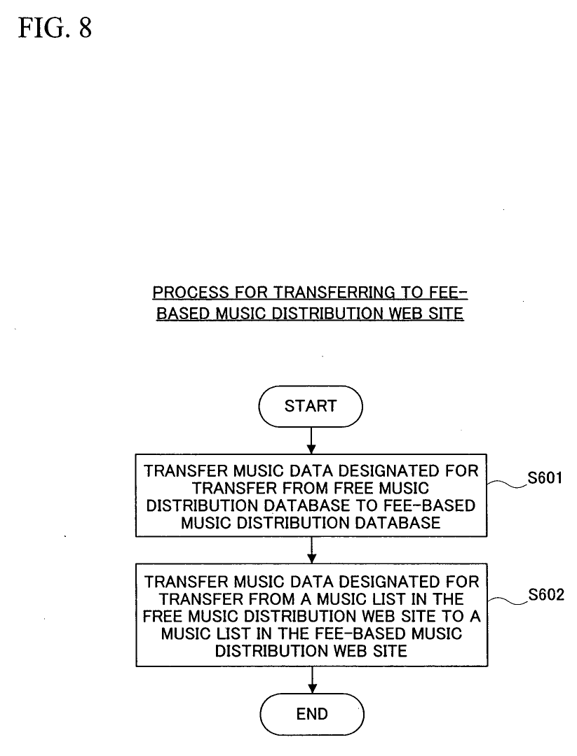

If there are music titles that are to be transferred to the fee-based music distribution Web site, corresponding music data is transferred from the free music distribution Web site to the fee-based music distribution Web site at step S107. The details of the transfer process at step S107 will be described later with reference to FIG. 8. If there is no music data that is to be transferred to the fee-based music distribution Web site, the routine ends.

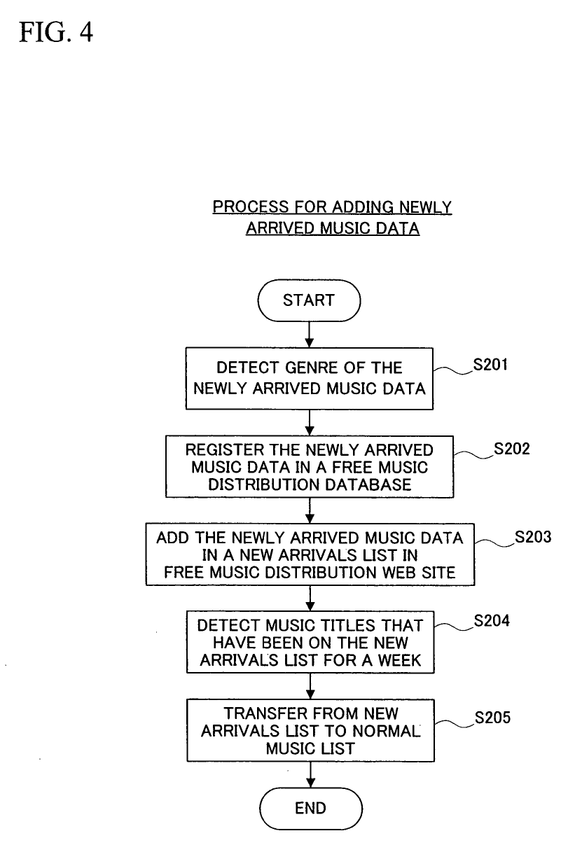

With reference to FIG. 4, a process for adding newly arrived music data is described. The music distribution server 1 is constantly accepting offers of music data. Singers and musicians can therefore submit music data they have produced to the music distribution server 1. Any type of music can be submitted, including sound recordings of vocals, choruses, and instrumentals. Administrators of the music distribution server 1 then screen the submitted items on the basis of musical quality, presence or absence of any matter offensive to public order and moral, and copyright, for example. Music data that has passed the screening is entered by the administrators into the music distribution server 1 via an input device.

At step S201, the genre of newly entered music data is detected by the music data addition/deletion processing unit 102, which then registers the newly arrived music data in the free music distribution database 301 at step S202. At step S203, the music data addition/deletion processing unit 102 adds the newly arrived music data in a new arrivals list in the free music distribution Web site.

At step S204, the music data addition/deletion processing unit 102 detects in the new arrivals list in the free music distribution Web site those music titles that have been on the list for more than a week since registration. At step S205, the music data addition/deletion processing unit 102 then transfers the thus detected music titles from the new arrivals list to the normal music lists.

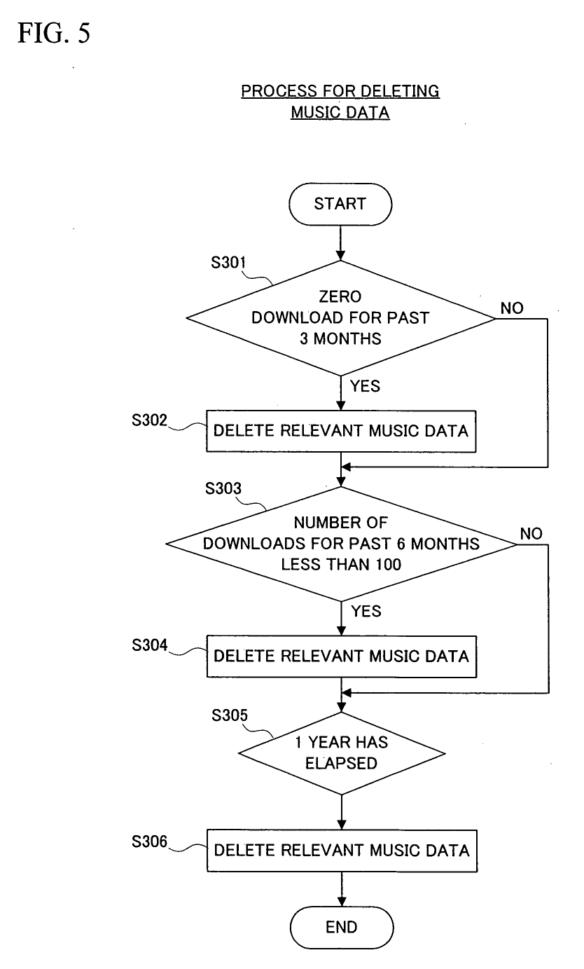

With reference to FIG. 5, a process for deleting music data is described. At step S301, the music data addition/deletion processing unit 102 detects those music titles that have been on the new arrivals list in the free music distribution Web site for more than 3 months without ever being downloaded even once. At step S302, the thus detected music titles are deleted from the music lists in the free music distribution Web site, and the corresponding music data is deleted from the free music distribution database 301 at the same time. At step S303, the music data addition/deletion processing unit 102 detects those music titles that have been on the new arrivals list in the free music distribution Web site for more than 6 months and that have been downloaded less than 100 times. The thus detected music titles are deleted from the free music lists in the free music Web site at step S304, and the corresponding music data is deleted from the free music distribution database 301 at the same time. At step S305, the music data addition/deletion processing unit 102 detects those music titles that have been on the new arrivals list in the free music distribution Web site for more than one year. At step S306, the thus detected music titles are deleted from the music lists in the free music distribution Web site, and the corresponding music data is also deleted from the free music distribution database 301 at the same time. At step S301, the number of downloads made by the singers or musicians who submitted the music data is not counted. Also, at step S303, the number of downloads made by the singers or musicians who submitted the music data, and the number of downloads repeatedly made by the same users are not counted.

With reference to FIG. 6, the process of tallying the number of download users at step S103 is described in detail. At step S401, the download user number tallying unit 104 identifies the users who downloaded music data, by referring to the user ID numbers, for example, that have been entered by the users during downloads. The music data in this case includes both the newly arrived music titles carried in the new arrivals list and the music titles carried in the normal music lists. At step S402, the download user number tallying unit 104 determines whether or not it was the first time that a particular user has downloaded a particular piece of music. If the particular music data has been downloaded by the same user in the past, or the download has been made by the singer or musician who provided the music data, the process terminates. If the user has downloaded the particular music data for the first time and he or she is not the person who offered the music data, the routine proceeds to step S403.

At step S403, the download user number tallying unit 104 counts the number of users who downloaded the music data. The result of tallying the number of download users is stored in the download number tallying database 302. At step S404, the download user number tallying unit 104 updates the music title rankings based on the result of tallying the number of download users. The ranking in the new arrivals list is displayed in real time; namely, it is updated for each download. The rankings in the normal music list are updated at certain time intervals, such as every 5 minutes, 10 minutes, or 1 hour, for example. These rankings are displayed on the free music distribution Web site.

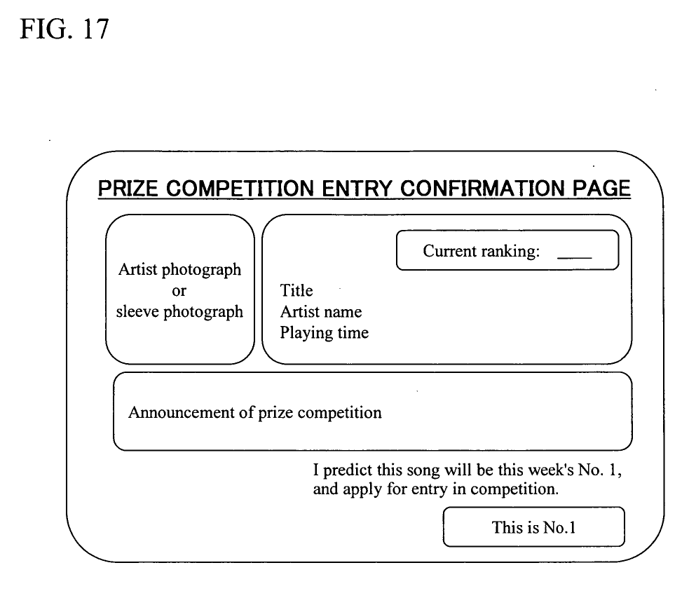

With reference to FIG. 7, the details of the competition application process at step S105 are described. At step S501, the competition application processing unit 110 receives applications for the competition from users. At step S502, the competition application processing unit 110 registers the contents of the competition applications in the competition application database 304. The contents of a competition application may include the user name, user ID number, the ID number of the music data that the user predicts will be at the top of the list, date/time of registration, and the current download ranking of the song. The contents of the competition application will be described later with reference to FIG. 17. At step S503, the competition application processing unit 110 determines whether or not the application period has elapsed, which lasts for a certain period of time from the day when particular newly arrived music data was registered, such as a week. At step S504, applications are closed, and a single winner is determined, by lottery if there is more than one entrant with the correct answer. At step S505, the winner is notified via e-mail or the like. The winner is rewarded in the form of prize money or a right to download a fee-based download piece of music for free, for example. If there are no entrants with the correct answer, the fact may be announced and the prize money or the like may be put aside for subsequent competitions.

With reference to FIG. 8, the details of the transfer process at step S107 are described. At step S601, the transfer processing unit 105 transfers the music data designated for transfer from the free music distribution database 301 to the fee-based music distribution database 305. At step S602, the transfer processing unit 105 transfers the music titles designated for transfer from the music lists in the free music distribution Web site to the music lists in the fee-based music distribution Web site.

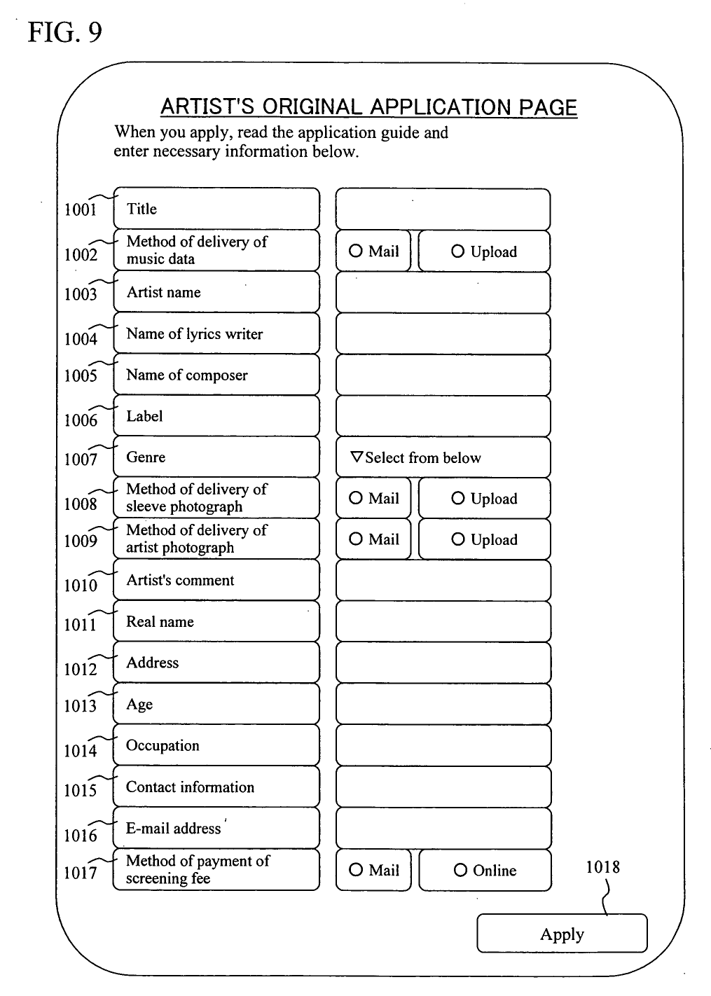

FIG. 9 shows an example of the Web page for soliciting music data. The page shows entry items including: title of song 1001; method of delivery of music data 1002; name of artist or musician 1003; name of lyrics writer 1004; name of composer 1005; name of the label to which the singer or musician belongs; genre 1007; method of delivery of sleeve photograph 1008; method of delivery of a photograph of the singer or musician 1009; comments from the singer or musician 1010; real name 1011; address 1012; age 1013; occupation 1014; contact information 1015; e-mail address 1016; and method of payment of screening fee 1017, for example.

The method of delivery of music data 1002, which indicates the method by which the applicant delivers his or her music data to the music distribution server 1, can be selected from options including “Mail,” by which the applicant sends a CD, DVD, or a tape by mail, for example, and “Upload,” by which the applicant uses a communications network such as the Internet. The genre name 1007 is selected from rock, hip-hop/R&B, vocal, pops, club/dance, jazz, classical, and world, for example. The sleeve photograph is the photograph to be inserted into the case of a CD, a DVD, or the like. The artist photograph is the photograph of the singer or musician to be displayed on the Web page. The method of delivery of the sleeve photograph and the artist photograph may be selected from “Mail” and “Upload.” The method of payment of screening fee 1017 may be selected from “Mail,” “Transfer,” and “Credit Card,” for example. The applicant enters these items displayed on the Web page and then clicks an “Apply” button 1018 at the bottom of the screen, whereby the application process is completed.

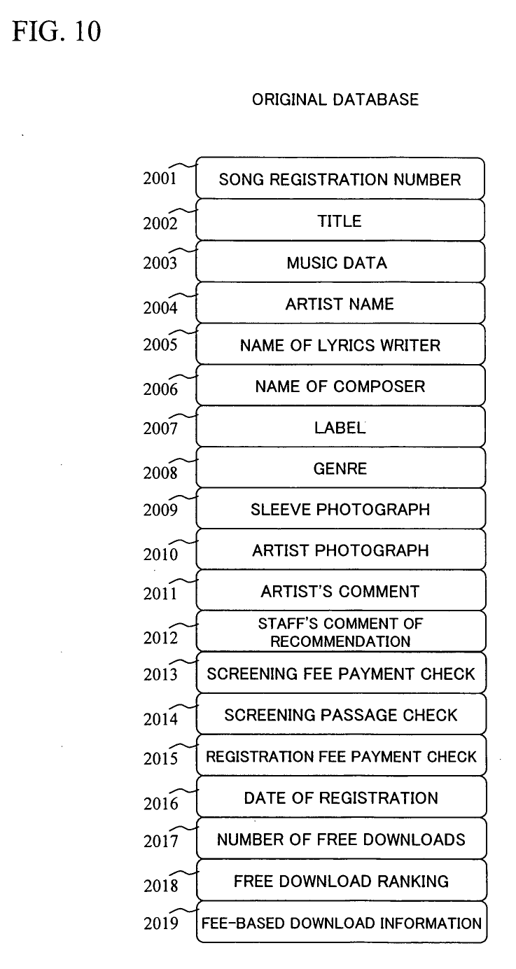

FIG. 10 shows an example of information contained in a set of music data registered in the original database 300. The information includes: song registration number 2001 for identifying a particular song; title of song 2002; music data 2003 that is distributed to the users; artist name 2004; name of lyrics writer 2005; name of composer 2006; label name 2007; and genre 2008.

The information in each set of music data further includes: sleeve photograph 2009; artist photograph 2010; artist's comments 2011; and staff's comment of recommendation 2012. The staff's comment of recommendation 2012 is a comment by the administrators of the music distribution server 1, which is made during the screening process, for example.

The information in each set of music data further includes: screening fee payment check 2013; screening passage check 2014; registration fee payment check 2015; and date of registration 2016. The screening fee payment check 2013 indicates whether or not the person who submitted music data has paid the screening fee. The screening passage check 2014 indicates whether or not particular music data has passed the screening. The registration fee payment check 2015 indicates whether or not the applicant of music data has paid the registration fee. The date of registration 2016 indicates the date on which particular music data passed the screening and was registered in the original database 300.

The song title 2002, artist name 2004, name of lyrics writer 2005, name of composer 2006, label name 2007, genre 2008, and artist's comment 2011 correspond to the song title 1001, artist name 1003, name of lyrics writer 1004, name of composer 1005, label name 1006, genre 1007, and artist's comment 1010, respectively, in the Web page for accepting submission of music data shown in FIG. 9.

The information in each set of music data further includes the number of downloads made from the free music distribution Web site 2017, ranking of the number of download users in the free music distribution Web site 2018, and information 2019 about fee-based download, for example.

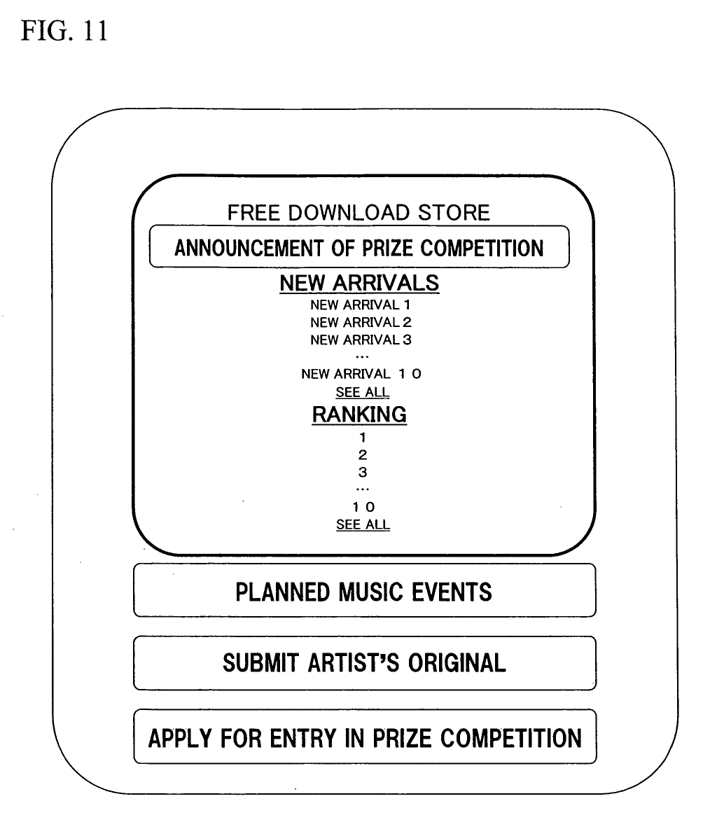

FIG. 11 shows an example of the “Free Download Store” in the free music distribution Web site provided by the free music distribution Web site management unit 101. This Web page is displayed in response to the users' entry of password, user ID number, and the like. The page shows “Free Download Store,” which is the title of the Web site, “New Arrivals,” and “Ranking,” for example. In the column for “New Arrivals,” the list of newly arrived music titles is partly shown. As described above with reference to FIG. 4, the music titles in the new arrivals list in the free music distribution Web site are transferred to the normal music list one week after they were first carried in the list. In the column “Ranking,” a ranking of the number of download users is displayed in order of descending numbers.

In this Web page, many icons are displayed that lead to links. For example, “See All” below “New Arrivals” is an icon for moving onto a page in which the new arrivals list can be seen in its entirety. Another “See All” icon below “Ranking” is an icon for displaying all of the rankings of the number of download users. A “Planned Music Event” button is an icon for displaying a page regarding planned music events. A “Submit Artist's Originals” button is an icon for displaying a page in which music data from singers or musicians is solicited. An “Apply for Entry in Prize Competition” button is an icon for moving to a page where user applications for entry in a competition are accepted.

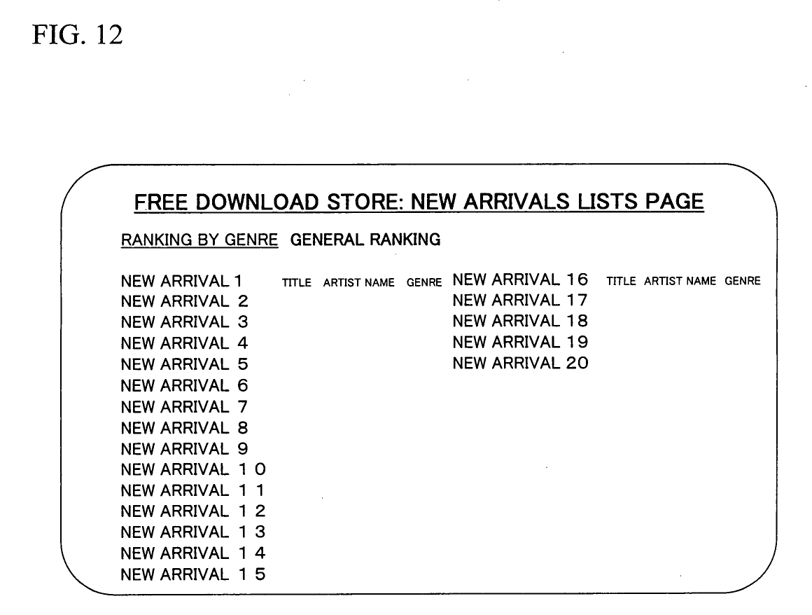

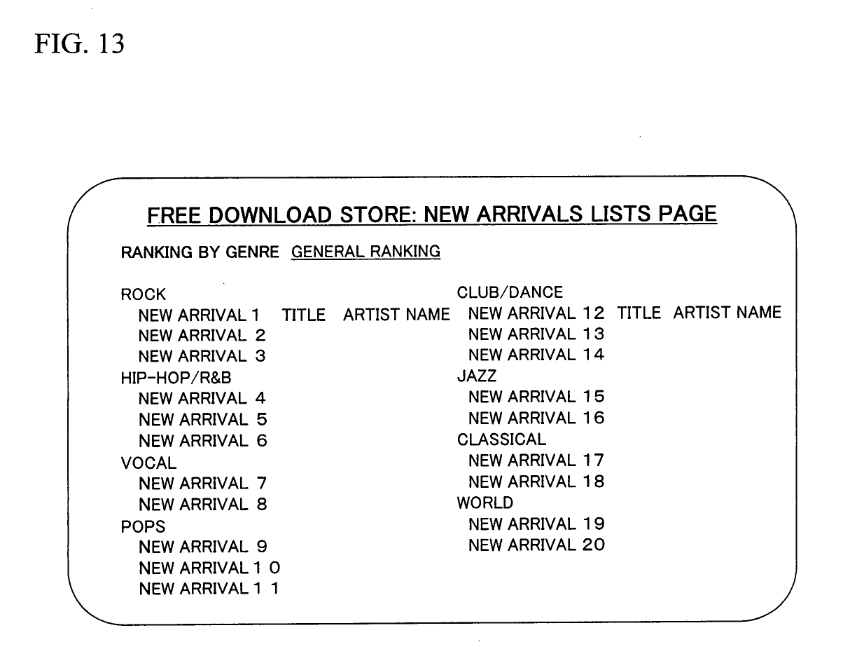

FIG. 12 shows an example of the page where the new arrivals list is displayed. In a “New Arrivals” column, a list of newly arrived music titles is displayed partially, such as 25 newest songs, for example, in order of registration. In the next page, additional 25 songs may be displayed. In the yet next page, further 25 songs may be displayed. FIG. 13 shows an example of a page in which lists of new arrivals are shown according to genre, also in order of registration.

While the above example involved Web pages where lists of newly arrived music titles are displayed, normal music lists may be displayed in a manner similar to those shown in FIGS. 12 and 13.

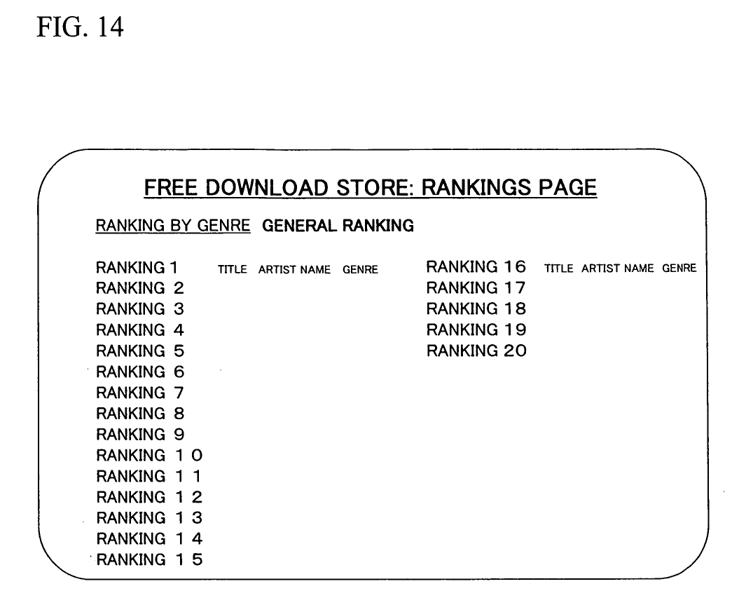

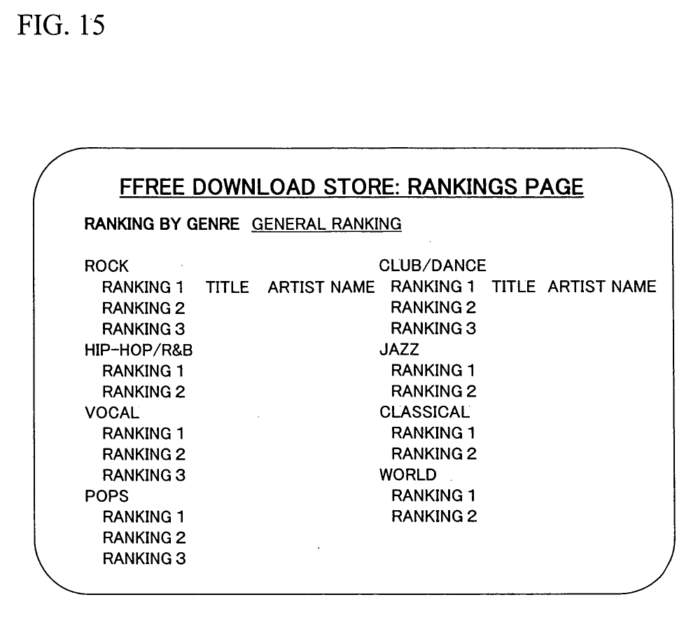

FIG. 14 shows an example of a page where a ranking of the number of download users is displayed for all of the music titles. FIG. 15 shows an example of a page where rankings of the number of download users are displayed according to genre. These rankings include both new arrivals and normal music titles.

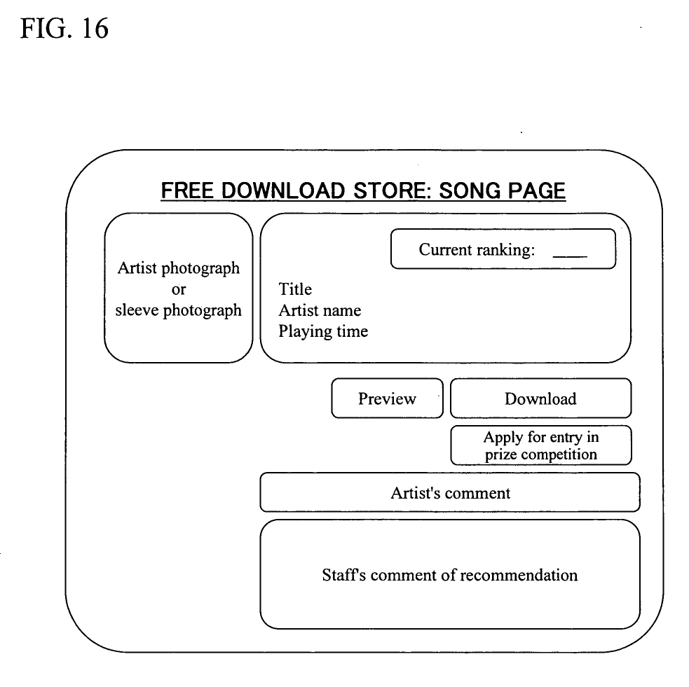

FIG. 16 shows an example of a page where music lists are displayed from which users can download music data. In the Web pages shown in FIGS. 11 to 15, as a user clicks a desired song name, the page shown in FIG. 16 is displayed. In this page, there are displayed the song title, artist name, playing time, current ranking, artist's photograph, sleeve photograph, artist's comment, and staff's comment, for example. The page further shows a “Preview” button, a “Download” button, and an “Apply for Entry in Prize Competition” button, for example. When the “Preview” button is clicked, an initial portion of the song is played back. When the “Download” button is clicked, the music data starts downloading into the user's terminal device. When the “Apply for Entry in Prize Competition” button is clicked, a competition entry page shown in FIG. 17 is displayed.

With reference to FIG. 17, an example of the competition entry page is described. The competition entry page shows the title of song, artist name, playing time, current ranking, sleeve photograph, and artist photograph, for example. In this page, there is further shown a column for the entry of user's comment of recommendation. When the user clicks a “This is No. 1” button, the competition entry procedure is completed.

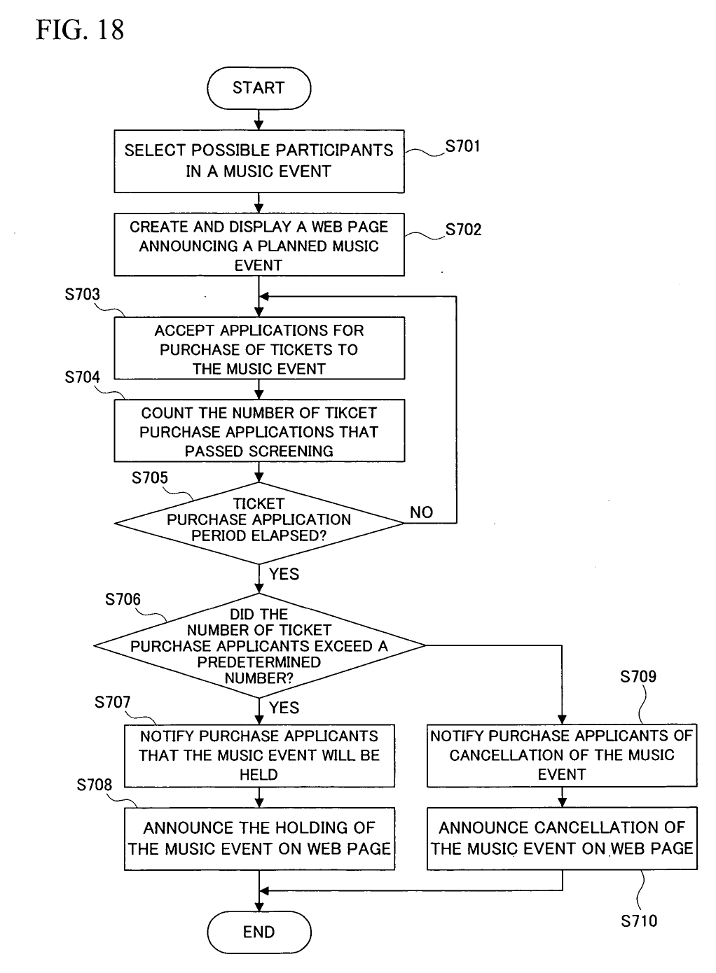

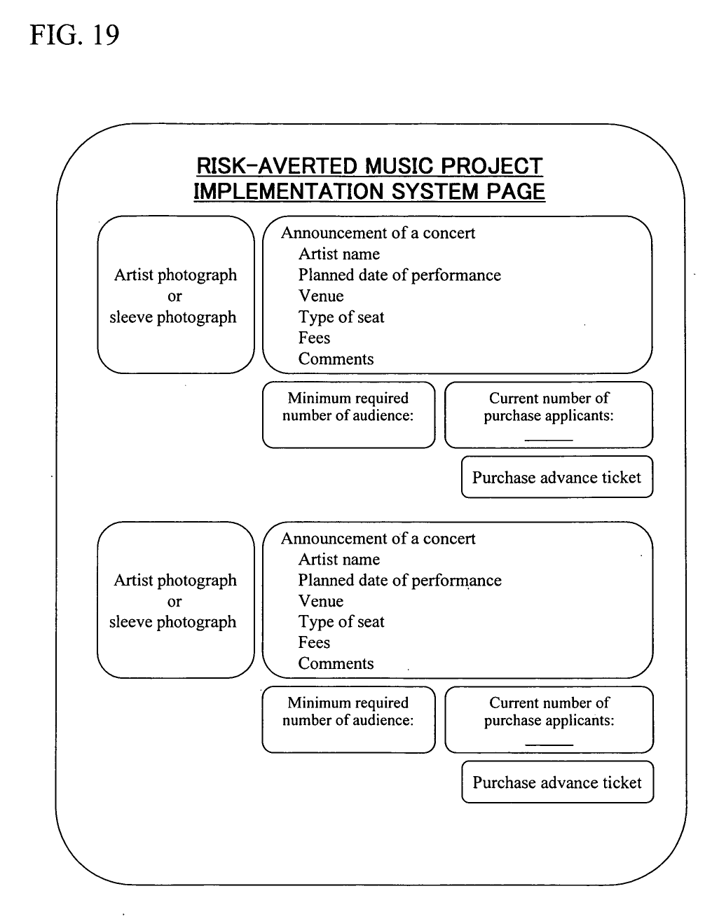

With reference to FIG. 18, the process performed in the music project implementation management unit 120 is described. At step S701, the music project implementation management unit 120 searches the fee-based music distribution database 305 for singers or musicians for whom a music event could be held. In order for singers or musicians to be eligible for participation in such a music event, certain conditions must be met, such as the number of download users of their music titles exceeding a predetermined number, or their music titles having been transferred to the fee-based music distribution site within a certain period of time in the past, for example. At step S702, the music project implementation management unit 120 creates a Web page that contains information regarding planned music events, involving the singers or musicians selected by the search. An example of such a Web page will be described with reference to FIG. 19.

At step S703, the music project implementation management unit 120 accepts applications from the users for the purchase of tickets to a music event. At step S704, the music project implementation management unit 120 screens the applications, and tallies the number of applications that have passed the screening. The screening is based on whether or not the predetermined columns in the application page are correctly filled and whether or not preparations for the payment of ticket fees have been made.

At step S705, the music project implementation management unit 120 determines whether or not the application period for the purchase of tickets has elapsed. If the period has elapsed, the routine proceeds to step S706 where the music project implementation management unit 120 determines whether or not the number of applicants for tickets has exceeded a predetermined number. If the predetermined number is exceeded, the routine proceeds to step S707 where the ticket applicants are notified of a decision to go ahead with the planned music event via e-mail or the like, and the applicants conduct a ticket fee payment process. At step S708, the music project implementation management unit 120 publicly announces the planned holding of the music event in the free music distribution Web site and the fee-based music distribution Web site. If the number of applicants for the purchase of tickets did not exceed the predetermined number, the routine proceeds to step S709 where the ticket purchase applicants are notified of the cancellation of the music event via e-mail, for example. At step S710, the music project implementation management unit 120 publicly announces the cancellation of the music event in the free music distribution Web site and the fee-based music distribution Web site.

With reference to FIG. 19, an example of the Web page regarding music events is described. The Web page in this example displays the name of artist, planned date of performance, venue, type of seats, fees, comments, artist photograph, sleeve photograph, minimum required number of audience, and the current number of ticket purchase applicants, for example. When a “Purchase Advance Ticket” button in this Web page is clicked, an advance ticket purchase page is displayed. The advance ticket purchase page includes columns for the address of the ticket purchase applicant, name, age, user number, and the method of payment of fee, for example, which are not shown in the drawings.

While the invention has been particularly shown and described with reference to preferred embodiments thereof, it will be understood by those skilled in the art that the foregoing and other changes in form and details can be made therein without departing from the scope of the invention and the appended claims.

1. A method of distributing music to terminal devices via a communications network, said method comprising the steps of:
opening a free music distribution Web site for distributing music data for free and a fee-based music distribution Web site for distributing music data for a fee;
distributing music data for free to a user when a request for the distribution of said music data is received from said user via said free music distribution Web site;
tallying the number of downloads each time said music data is distributed in the distribution step; and
transferring said music data from said free music distribution Web site to said fee-based music distribution Web site based on the result of tallying of the number of downloads.

2. The method of distributing music according to claim 1, wherein, based on the result of tallying of the number of downloads in the download number tallying step, a ranking of music data is created in order of descending number of downloads, wherein the ranking is displayed in said free music distribution Web site.

3. The method of distributing music according to claim 1, wherein the number of downloads tallied in the download number tallying step is the number of users who downloaded said music data.

4. The method of distributing music according to claim 1, wherein, when newly arrived music data is entered, said newly arrived music data is added to a music list in said free music distribution Web site.

5. The method of distributing music according to claim 1, wherein music data of which the number of downloads does not reach a predetermined number after a predetermined period has passed since said music data was carried on a music list in said free music distribution Web site is deleted.

6. The method of distributing music according to claim 1, wherein music data that has been on a music list in said free music distribution Web site for a predetermined period is deleted.

7. The method of distributing music according to claim 1, comprising the step of accepting applications for entry in a prize competition from users to which music data has been distributed for free in the distribution step, said competition involving the users predicting which music title will be at the top of a download number ranking within a predetermined application period.

8. The method of distributing music according to claim 1, comprising publicly announcing a planned holding of a music event involving music data that is determined to require transfer to said fee-based music distribution Web site which satisfies certain conditions, as well as the minimum number of audience required for a decision to hold said music event, and displaying a ticket-sales advertising page in said free music distribution Web site and said fee-based music distribution Web site.

9. The method of distributing music according to claim 8, wherein if the number of applicants for the purchase of the tickets for said music event exceeded the predetermined minimum number of audience within a predetermined application period, the ticket purchase applicants are notified that said music event will be held, and wherein if the number of the ticket purchase applicants did not exceed the predetermined minimum number of audience within the predetermined application period, the ticket purchase applicants are notified of cancellation of said music event.

10. A computer-readable program for causing a computer to carry out the method of distributing music to terminal devices via a communications network, said method comprising the steps of: opening a free music distribution Web site for distributing music data for free and a fee-based music distribution Web site for distributing music data for a fee: distributing music data for free to a user when a request for the distribution of said music data is received from said user via said free music distribution Web site, tallying the number of downloads each time said music data is distributed in the distribution step; and transferring said music data from said free music distribution Web site to said fee-based music distribution Web site based on the result of tallying of the number of downloads.

11. A music distribution apparatus comprising:
a Web site management unit for managing a free music distribution Web site for distributing music data for free and a fee-based music distribution Web site for distributing music data for a fee;
a free music data distribution processing unit for distributing music data for free in accordance with a request from a user;
a download number tallying processing unit for tallying the number of downloads for each item of music data distributed for free; and
a transfer processing unit for transferring music data from said free music distribution Web site to said fee-based music distribution Web site based on the result of tallying of the number of downloads.

12. The music distribution apparatus according to claim 11, wherein said download number tallying processing unit tallies the number of users who downloaded music data as the number of downloads, creates a ranking of music data in order of decreasing number of downloads based on the result of tallying of the number of downloads, and causes said ranking to be displayed on said free music distribution Web site.

13. The music distribution apparatus according to claim 11, wherein said free music distribution Web site further includes a music data addition/deletion processing unit for adding or deleting music data, wherein said music data addition/deletion processing unit adds newly arrived music data onto said free music distribution Web site.

14. The music distribution apparatus according to claim 13, wherein said music data addition/deletion processing unit deletes music data that has been on a music list in said free music distribution Web site for a predetermined period without being downloaded more than a predetermined number of times.

15. The music distribution apparatus according to claim 13, wherein said music data addition/deletion processing unit deletes music data that has been on a music list on said free music distribution Web site for a predetermined period.

16. The music distribution apparatus according to claim 11, further comprising a prize competition application processing unit for accepting applications for entry in a prize competition in which users predict which music data will be at the top of a ranking of the number of downloads within a predetermined application period, wherein said prize competition application processing unit closes applications for entry in said competition after said predetermined application period has elapsed and then determines a winner of a prize.

17. The music distribution apparatus according to claim 11, further comprising a music project implementation management unit for managing a music project that is held if the number of applicants for the purchase of tickets to such music event exceeds a predetermined minimum required number of audience in said music event, wherein said music project implementation management unit displays an announcement page in said free music distribution Web site and said fee-based music distribution Web site, publicly announcing that a music event will be held involving music data that is determined to require transfer to said fee-based music distribution site which satisfies certain conditions.
